(19) United States
(12) Patent Application Publication
(10) Pub. No.: US 2026/0097536 A1
(43) Pub. Date: Apr. 9, 2026

(54) UNIT FOR CUTTING APPARATUS, CUTTING APPARATUS, AND METHOD FOR MANUFACTURING SHEET FRAGMENT

(71) Applicant: KYOCERA CORPORATION, Kyoto-shi, Kyoto (JP)

(72) Inventor: Shigetaka HASHIMOTO, Konan-shi, Shiga (JP)

(21) Appl. No.: 19/114,789

(22) PCT Filed: Sep. 21, 2023
(86) PCT No.: PCT/JP2023/034208

§ 371 Date: Mar. 25, 2025

(30) Foreign Application Priority Data
Sep. 27, 2022 (JP) 2022-153604

(51) Int. Cl. B26D 1/24; B26D 5/06; B26D 7/26; B65H 35/00; B65H 35/02

(52) U.S. Cl. CPC B26D 1/245; B26D 5/06; B26D 7/2621; B26D 7/265; B65H 35/0086; B65H 35/02

(57) ABSTRACT

In a unit for a cutting apparatus in a non-limiting embodiment of the present disclosure, a second shaft, a first blade member, and a second blade member individually have conductivity. A detection means includes a power source, a connection terminal attached to a holder, a light emitting device attached to the holder, first wiring that electrically connects the connection terminal and the power source, second wiring that electrically connects the second shaft and the power source, third wiring that electrically connects the light emitting device and the connection terminal, and fourth wiring that electrically connects the light emitting device and the first blade member.

### CROSS-REFERENCE TO RELATED APPLICATION

The present application claims priority to Japanese Patent Application No. 2022-153604, filed Sep. 27, 2022. The contents of this application are incorporated herein by reference in their entirety.

### TECHNICAL FIELD

The present disclosure relates to a unit used for a cutting apparatus that cuts down a member having a sheet shape in a predetermined width, the cutting apparatus, and a method for manufacturing a sheet fragment. Examples of the member having the sheet shape may include members, such as metal foils, papers, and resin films.

### BACKGROUND

For example, slitter apparatuses discussed in Japanese Unexamined Patent Application Publication No. 1-321197 (Patent Document 1) and Japanese Unexamined Utility Model Application Publication No. 4-122488 (Patent Document 2) are known as a cutting apparatus that cuts down a member having a sheet shape. The slitter apparatus discussed in Patent Document 1 includes a plurality of blades having a ring shape, and a plurality of lamps respectively electrically connected to the plurality of blades. The slitter apparatus discussed in Patent Document 2 also includes a plurality of thin blades having a ring shape, and a plurality of light emitting devices respectively electrically connected to the plurality of thin blades. In both slitter apparatuses discussed in Patent Documents 1 and 2, the lamps (light emitting devices) are used to detect a contact state of the blades (the thin blades).

In both slitter apparatuses discussed in Patent Documents 1 and 2, the lamps are attached to an apparatus body. When cutting down the member having the sheet shape, the number and position of the blades may be changed in order to obtain a cut piece with a desired width. Hence, it might be difficult to understand a corresponding relationship between the lamps and the blades.

### SUMMARY

A unit for a cutting apparatus in a non-limiting embodiment of the present disclosure includes a base, a first shaft, a holder, a first blade member, a second shaft, a second blade member, and a detection means. The first shaft is attached to the base and extends along a first rotation axis. The holder having a cylindrical shape is attached to the first shaft. The first blade member having an annular shape is attached to the holder. The second shaft is attached to the base and extends along a second rotation axis parallel to the first rotation axis. The second blade member having a cylindrical shape is attached to the second shaft. The detection means detects contact of the first blade member and the second blade member.

The second shaft, the first blade member, and the second blade member individually have conductivity. The detection means includes a power source, a connection terminal attached to the holder, a light emitting device attached to the holder, first wiring electrically connecting the connection terminal and the power source, second wiring electrically connecting the second shaft and the power source, third wiring electrically connecting the light emitting device and the connection terminal, and fourth wiring electrically connecting the light emitting device and the first blade member.

### BRIEF DESCRIPTION OF THE DRAWINGS

FIG. 1 is a perspective view illustrating a unit for a cutting apparatus in a non-limiting embodiment of the present disclosure;

FIG. 2 is a perspective view of a holder and a first blade member in the unit for the cutting apparatus illustrated in FIG. 1;

FIG. 3 is a diagram of the holder and the first blade member illustrated in FIG. 2 as viewed from a direction vertical to an outer circumferential surface of the holder;

FIG. 4 is an exploded view of the holder illustrated in FIG. 3;

FIG. 5 is a plan view of the holder and the first blade member illustrated in FIG. 3 as viewed from a direction of V;

FIG. 6 is an enlarged view of a region VI illustrated in FIG. 5;

FIG. 7 is a sectional view taken along line VII-VII illustrated in FIG. 6;

FIG. 8 is a perspective view illustrating a holder in a unit for a cutting apparatus in a non-limiting embodiment of the present disclosure;

FIG. 9 is a sectional view of a state where a first blade member is attached to the holder illustrated in FIG. 8, FIG. 9 corresponding to FIG. 7;

FIG. 10 is a perspective view illustrating a holder and a first blade member in a unit for a cutting apparatus in a non-limiting embodiment of the present disclosure;

FIG. 11 is a plan of the holder and the first blade member illustrated in FIG. 10, FIG. 11 corresponding to FIG. 5;

FIG. 12 is a sectional view taken along line XII-XII illustrated in FIG. 11; and

FIG. 13 is a schematic diagram illustrating a cutting apparatus (a method for manufacturing a sheet fragment) in a non-limiting embodiment of the present disclosure.

### EMBODIMENTS

### Unit for Cutting Apparatus

A unit for a cutting apparatus 1 in a non-limiting embodiment of the present disclosure (hereinafter referred to as “a unit 1” in some cases) is described in detail below with reference to the drawings. For the convenience of description, the drawings referred to in the following illustrate, in simplified form, only main members necessary for describing the embodiments. The unit 1 may therefore include any arbitrary structural member not illustrated in the drawings referred to. Dimensions of the members in each of the drawings faithfully represent neither dimensions of actual structural members nor dimensional ratios of these members.

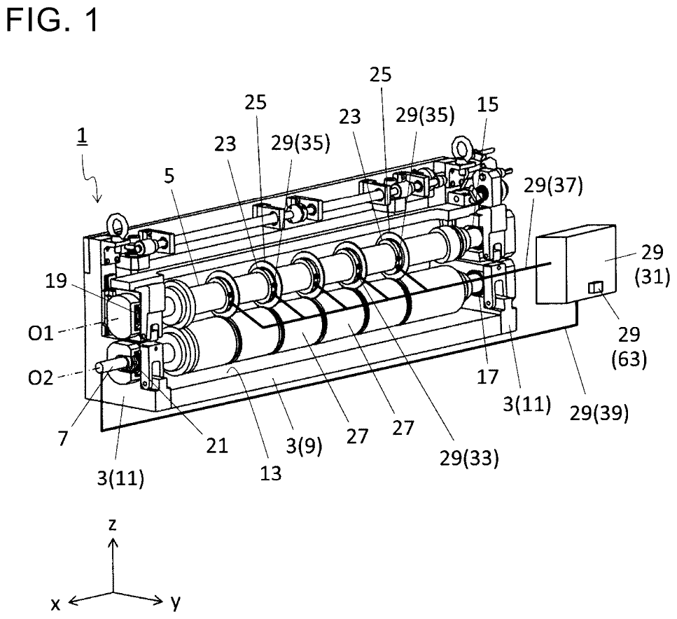

The unit 1 may include a base 3, a first shaft 5, and a second shaft 7 as in a non-limiting embodiment illustrated in FIG. 1.

The first shaft 5 may be attached to the base 3. The first shaft 5 may be detachably attached to the base 3. The first shaft 5 may extend along a first rotation axis O1. The first shaft 5 is rotatable around the first rotation axis O1.

The first shaft 5 is not limited to having specific dimensions. For example, a length of the first shaft 5 in a direction along the first rotation axis O1 may be set to approximately 300-4000 mm. A width (diameter) of the first shaft 5 in a direction orthogonal to the first rotation axis O1 may be set to approximately 30-150 mm. A cross section orthogonal to the first rotation axis O1 in the first shaft 5 may have a circular shape.

The second shaft 7 may be attached to the base 3. The second shaft 7 may be detachably attached to the base 3. The second shaft 7 may extend along a second rotation axis O2. The second shaft 7 is rotatable around the second rotation axis O2.

The second shaft 7 is located below the first shaft 5. The second shaft 7 is rotatable in a direction opposite to the first shaft 5. For example, in cases where gears that mesh with each other are respectively attached to the first shaft 5 and the second shaft 7, if the first shaft 5 is rotated, the second shaft 7 is rotatable in the direction opposite to the first shaft 5 according to the rotation of the first shaft 5.

The second rotation axis O2 may be parallel to the first rotation axis O1. The term “parallel” as used herein is not limited to be a strict parallel, but may mean that it allows for an inclination of approximately ±5°. The second rotation axis O2 may be overlapped with the first rotation axis O1 in plan view of the unit 1 from a side of the first shaft 5.

The second shaft 7 is not limited to having specific dimensions. For example, a length of the second shaft 7 in a direction along the second rotation axis O2 may be set to approximately 300-4000 mm. A width (diameter) of the second shaft 7 in a direction orthogonal to the second rotation axis O2 may be set to approximately 30-150 mm. A cross section of the second shaft 7 orthogonal to the second rotation axis O2 may have a circular shape.

The base 3 may include a lower plate part 9 and a pair of sidewall parts 11 fixed to the lower plate part 9 with their respective main surfaces opposed to each other. The lower plate part 9 may include an upper surface 13 having a rectangular shape. The pair of sidewall parts 11 may be fixed to the lower plate part 9 along a short side of the upper surface 13. The first shaft 5 and the second shaft 7 may be located parallel to the upper surface 13 of the lower plate part 9.

The lower plate part 9 is not limited to having specific dimensions. For example, a width of the lower plate part 9 in x-axis direction in the non-limiting embodiment illustrated in FIG. 1 may be set to approximately 400-5000 mm. A width of the lower plate part 9 in y-axis direction may be set to approximately 100-500 mm. A width (thickness) of the lower plate part 9 in z-axis direction may be set to approximately 20-100 mm.

In the non-limiting embodiment illustrated in FIG. 1, the direction parallel to the first rotation axis O1 and the second rotation axis O2 may be the x-axis direction. The direction orthogonal to the x-axis direction and parallel to the upper surface 13 of the lower plate part 9 may be the y-axis direction. The direction that is a vertical direction in FIG. 1 and is orthogonal to the x-axis direction and the y-axis direction may be the z-axis direction.

The pair of sidewall parts 11 may individually include a first support part 15 and a second support part 17 that are independent of each other.

The first support part 15 is configured to permit attachment of the first shaft 5. The unit 1 may include a pair of first bearing members 19 respectively attached to opposite end portions of the first shaft 5. The first shaft 5 may be attached to the first support part 15 by holding the first bearing members 19 with the first support part 15. In these cases, it is easy to rotate the first shaft 5 while stably holding the first shaft 5 with the first support part 15.

Examples of the first bearing member 19 may include a bearing having an annular shape. This bearing may be rephrased as a first bearing. The first bearing is not limited to having specific dimensions. For example, an outer diameter of the first bearing may be set to approximately 30-150 mm.

The second support part 17 may be located below the first support part 15. The second support part 17 is configured to permit attachment of the second shaft 7. The unit 1 may include a pair of second bearing members 21 attached to opposite end portions of the second shaft 7. The second shaft 7 may be attached to the second support part 17 by holding the second bearing members 21 with the second support part 17. In these cases, it is easy to rotate the second shaft 7 while stably holding the second shaft 7 with the second support part 17.

Examples of the second bearing member 21 may include a bearing having an annular shape. This bearing may be rephrased as a second bearing. The second bearing is not limited to having specific dimensions. For example, an outer diameter of the second bearing may be set to approximately 30-150 mm.

The pair of sidewall parts 11 are not limited to having specific dimensions. For example, a width (thickness) of the sidewall parts 11 in the x-axis direction may be set to approximately 10-60 mm. A width of the sidewall parts 11 in the y-axis direction may be set to approximately 100-500 mm. A width of the sidewall parts 11 in the z-axis direction may be set to approximately 200-800 mm.

The base 3 may be configured to have strength sufficient for stably holding the first shaft 5 and the second shaft 7. Therefore, the base 3 is not limited to having a structure formed by the lower plate part 9 and the pair of sidewall parts 11. For example, the base 3 may be a structure having such a concave shape that the lower plate part 9 and the pair of sidewall parts 11 are formed integrally. Examples of material of the base 3 may include steel and stainless steel.

The unit 1 may include a holder 23. The holder 23 may have a cylindrical shape. The holder 23 may be attached to the first shaft 5. The holder 23 may be detachably attached to the first shaft 5. The holder 23 may serve as a member that fixes a first blade member 25 described later to the first shaft 5.

The unit 1 may include a plurality of holders 23. The holders 23 adjacent to each other may be in contact with each other or separated from each other. The number of the holders 23 may be 1 to 30.

The unit 1 may include the first blade member 25. The first blade member 25 may have an annular shape. The first blade member 25 may be attached to the holder 23. The first blade member 25 may be detachably attached to the holder 23.

The unit 1 may include a plurality of first blade members 25. The number of the first blade members 25 may be 1 to 30. The number of the first blade members 25 may be equal to the number of the holders 23. The first blade member 25 may be a member having a disk shape or dish shape. The first blade member 25 may also be called a circular blade.

In cases where the holder 23 is attached to the first shaft 5, and the first blade member 25 is attached to the holder 23, the first blade member 25 is fixable to the first shaft 5 with the holder 23 interposed therebetween. Consequently, during rotation of the first shaft 5, the first blade member 25 is also rotatable according to the rotation of the first shaft 5. In cases where the unit 1 includes the plurality of holders 23 and the plurality of first blade members 25, upon adjustment of spacing between the holders 23 adjacent to each other, spacing between the first blade members 25 adjacent to each other is also adjustable accordingly.

The unit 1 may include a second blade member 27. The second blade member 27 may have a cylindrical shape. The second blade member 27 may be attached to the second shaft 7. The second blade member 27 may be detachably attached to the second shaft 7. If the second blade member 27 is attached to the second shaft 7, the second blade member 27 is also rotatable according to the rotation of the second shaft 7. The unit 1 may include a plurality of second blade members 27. The number of the second blade members 27 may be 1 to 30.

The second blade member 27 may be attached to the second shaft 7 so that a lateral surface of the second blade member 27 can come into contact with a lateral surface of the first blade member 25. In this case, due to contact between the lateral surface of the first blade member 25 that is relatively susceptible to elastic deformation, and the lateral surface of the second blade member 27 that is relatively less susceptible to elastic deformation, shear force can occur between the first blade member 25 and the second blade member 27. Then it becomes possible to cut down a member having a sheet shape by the shear force. Thus, the member having the sheet shape and a relatively large width which is fed to the unit 1 can be cut down into a sheet processed product (sheet fragment) having a relatively small width by the first blade member 25 and the second blade member 27.

The second shaft 7, the first blade member 25, and the second blade member 27 may individually have conductivity. For example, these members may be made of a material having conductivity. £ Examples of the material having conductivity may include copper, steel, stainless steel, and aluminum.

A surface of each of the second shaft 7, the first blade member 25, and the second blade member 27 may have conductivity. For example, these members may be configured to include a substrate having insulation properties, and a coating film that is located on the substrate and has conductivity.

Examples of material of the substrate having insulation properties may include resin, ceramics, and DLC (Diamond Like Carbon). Examples of the resin may include polyethylene, polypropylene, polystyrene, and polyvinyl chloride. Examples of the ceramics may include alumina (Al₂O₃), zirconia (ZrO₂), aluminum nitride (AlN), silicon carbide (SiC), and silicon nitride (Si₃N₄).

Examples of the material of the coating film having conductivity may include Ti-based coating containing Ti. Examples of the Ti-based coating may include TiN, Tic, TiCN, TiAIN, TiAlCN, and TiAlON. The coating film having conductivity may be rephrased as a conductive film. The coating film may be located on the substrate by using chemical vapor deposition (CVD) method or physical vapor deposition (PVD) method.

At least one of the second shaft 7, the first blade member 25, and the second blade member 27 may be made of a material having conductivity, and the rest may be configured to include a substrate having insulation properties, and a coating film that is located on the substrate and has conductivity.

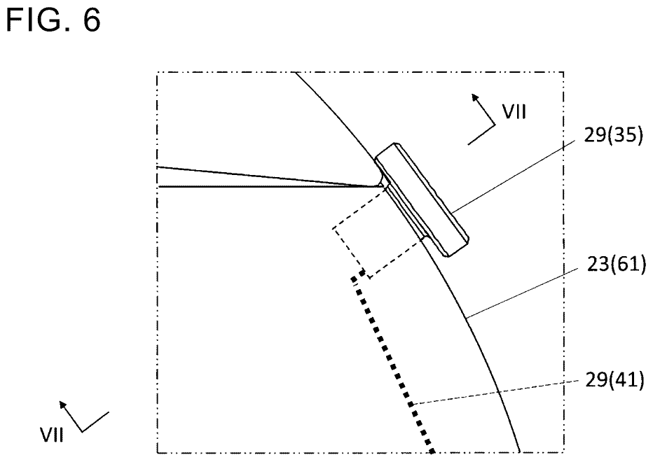

The unit 1 may include a detection means 29 for detecting contact of the first blade member 25 and the second blade member 27. As in the non-limiting embodiment illustrated in FIGS. 1 to 7, the detection means 29 may include a power source 31, a connection terminal 33, a light emitting device 35, first wiring 37, second wiring 39, third wiring 41, and fourth wiring 43.

The connection terminal 33 may be attached to the holder 23. The light emitting device 35 may be attached to the holder 23. The first wiring 37 may be electrically connected to the connection terminal 33 and the power source 31. The second wiring 39 may be electrically connected to the second shaft 7 and the power source 31. The third wiring 41 may be electrically connected to the light emitting device 35 and the connection terminal 33. The fourth wiring 43 may be electrically connected to the light emitting device 35 and the first blade member 25.

In these cases, the light emitting device 35 is attached to the holder 23, instead of the base 3. Therefore, it is easy to understand a corresponding relationship between the light emitting device 35 and the first blade member 25 even if the position of the first blade member 25 is changed. Additionally, a circuit can be configured in the detection means 29 by the first wiring 37, the second wiring 39, the third wiring 41, and the fourth wiring 43. Therefore, it is possible to introduce the detection means to an existing unit for a cutting apparatus in which the first shaft 5 and the second shaft 7 generally have conductivity, without adding a complex modification to the unit.

That is, the base 3, the first shaft 5, and the second shaft 7 are generally made of metal having conductivity, such as steel and stainless steel, in the existing unit for the cutting apparatus. In cases where both of the first shaft 5 and the second shaft 7 are used as a part of an electrical circuit in the detection means when attaching the detection means for detecting contact of the first blade member 25 and the second blade member 27 to the unit 1, an electrical shortcut between the base 3, the first shaft 5, and the second shaft 7 can become a problem. Therefore, an insulating coating is needed for any one of the base 3, the first shaft 5, and the second shaft 7. However, because all of the base 3, the first shaft 5, and the second shaft 7 are large components, it is not easy to apply the insulating coating to these components, and high cost of remodeling might be needed.

Meanwhile, the first shaft 5 is not used as a part of the electrical circuit in the detection means 29 of the present disclosure. The electrical circuit in the detection means 29 is formed by, for example, the connection terminal 33 attached to the holder 23, and the first wiring 37 electrically connected to the connection terminal 33 and the power source 31. Specifically, it is possible to avoid a situation where the first shaft 5 becomes a part of the electrical circuit by applying an insulating coating to a part of the holder 23 which comes into contact with the first shaft 5, or by forming the holder 23 by an insulating material.

The holder 23 is a component that is smaller, lighter in weight, and inexpensive than the first shaft 5. Therefore, it is possible to introduce the detection means 29 into the existing unit for the cutting apparatus only by replacing the holder 23 without carrying out the complex remodeling that requires the high cost of the remodeling.

As described above, the first wiring 37, the second wiring 39, the third wiring 41, and the fourth wiring 43 are members for electrically connecting the detection means 29 and the power source 31 so as to configure the circuit. Hence, the first wiring 37, the second wiring 39, the third wiring 41, and the fourth wiring 43 need not be strictly “wiring.” For example, these wiring may be partially configured by “a terminal.”

Examples of the light emitting device 35 may include lamps and LEDs. The unit 1 may include a plurality of light emitting devices 35. The number of the light emitting devices 35 may be 1 to 30. The number of the light emitting devices 35 may be equal to the number of the holders 23.

The holder 23 may have insulation properties as described above. In this case, the holder 23 is less likely to be electrically shorted with the first shaft 5, and it is easy to form the third wiring 41 and the fourth wiring 43. For example, the holder 23 may be made of a material having insulation properties. Examples of the material having insulation properties may include the same materials as those exemplified above in the substrate having insulation properties.

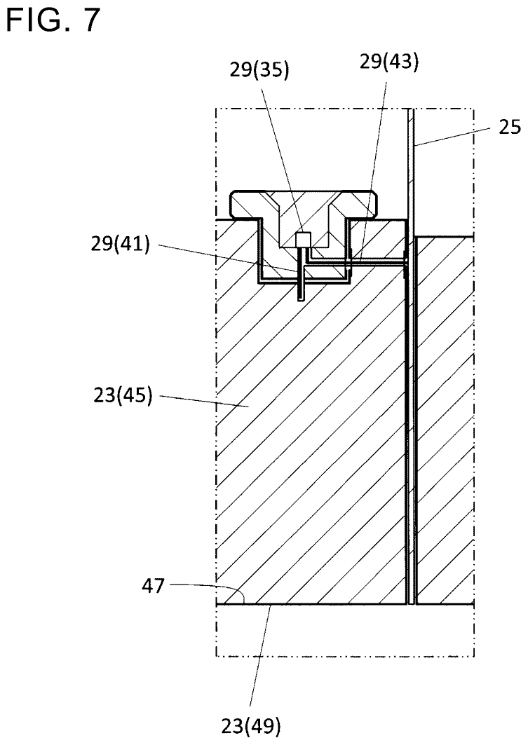

The surface of the holder 23 may have insulation properties. For example, the holder 23 may include a main body 45 having a cylindrical shape, an inner circumferential surface 47 of the main body 45, and a coating film 49 located on the inner circumferential surface 47 as in the non-limiting embodiment illustrated in FIG. 7. The main body 45 of the holder 23 may have conductivity, and the coating film 49 may have insulation properties.

If the main body 45 of the holder 23 has conductivity, the main body 45 may be utilized as the third wiring 41 or the fourth wiring 43 while paying attention to electrical short circuit of the third wiring 41 and the fourth wiring 43. For example, the main body 45 may be utilized as the fourth wiring 43 in a state where the third wiring 41 covered with an insulating material is embedded in the main body 45. Similarly, the main body 45 may be utilized as the third wiring 41 in a state where the fourth wiring 43 covered with an insulating material is embedded in the main body 45.

Examples of material of the main body 45 having conductivity may include the same materials as those exemplified above in the second shaft 7, etc. Examples of material of the coating film 49 having insulation properties may include resins, ceramics, and DLC (Diamond Like Carbon). The coating film 49 having insulation properties may also be located on other surface in the main body 45 in addition to the inner circumferential surface 47. The coating film 49 having insulation properties may be rephrased as an insulating film.

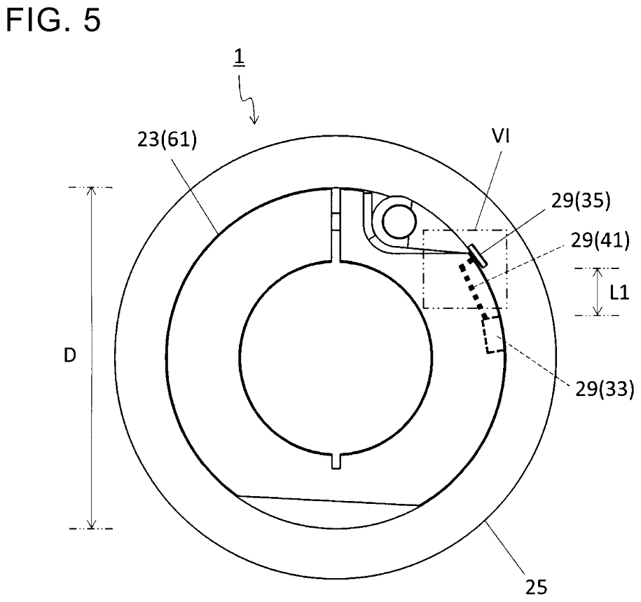

Spacing L1 between the connection terminal 33 and the light emitting device 35 may be a half or less of an outer diameter D of the holder 23 as in a non-limiting embodiment illustrated in FIG. 5. This makes it possible to decrease a length of the third wiring 41, thereby contributing to reduction in manufacturing costs and improvement in rigidity of the holder 23.

The spacing L1 and the outer diameter D are not limited to specific dimensions. For example, the spacing L1 may be set to approximately 5-80 mm. The outer diameter D may be set to approximately 60-180 mm.

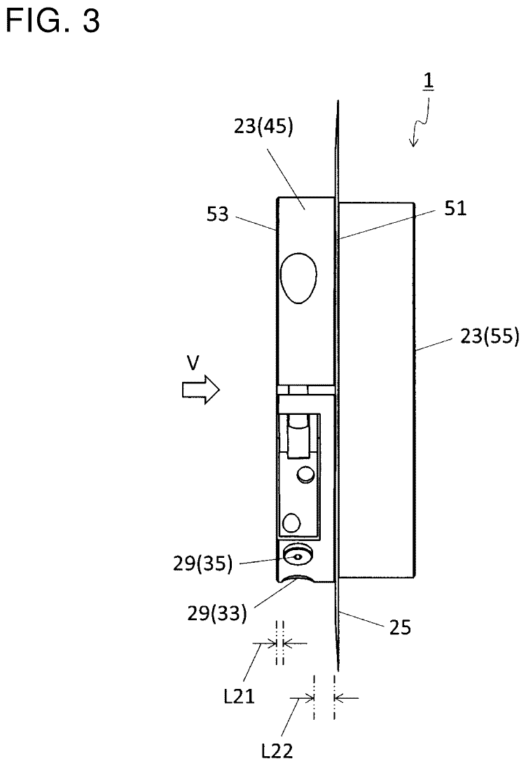

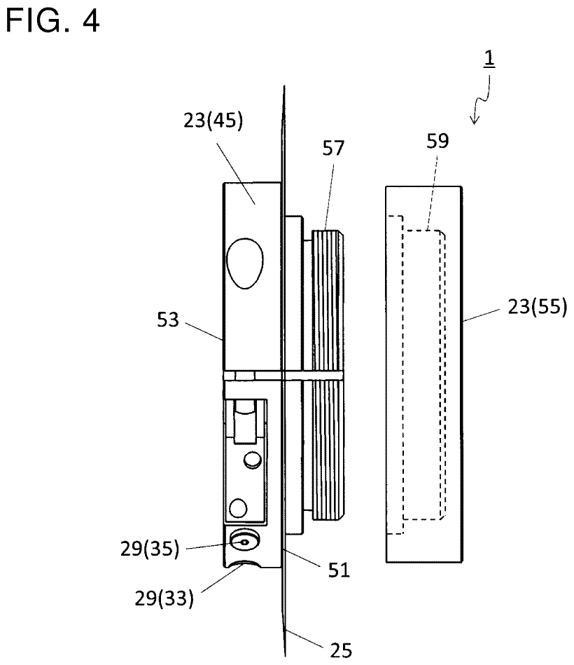

The holder 23 may include a first main surface 51 and a second main surface 53 as in a non-limiting embodiment illustrated in FIGS. 3 and 4. The second main surface 53 may be located on a side opposite to the first main surface 51. The first blade member 25 may come into contact with the first main surface 51.

If the holder 23 includes the main body 45, the main body 45 may include the first main surface 51 and the second main surface 53. In this situation, the holder 23 may further include a lid body 55. The lid body 55 may serve as a member for fixing the first blade member 25 to the main body 45.

For example, the main body 45 may include a male screw 57 located on the first main surface 51 as in a non-limiting embodiment illustrated in FIG. 4. The lid body 55 may include a female screw 59 to be fixed to the male screw 57. The first blade member 25 may be located between the first main surface 51 and the lid body 55. In these cases, by fixing the female screw 59 to the male screw 57, it becomes possible to attach the lid body 55 to the main body 45. It also becomes possible to attach the first blade member 25 to the main body 45 in a state where the first blade member 25 is in contact with the first main surface 51.

The connection terminal 33 and the light emitting device 35 may be located closer to the second main surface 53 than the first main surface 51 as in the non-limiting embodiment illustrated in FIG. 3. In other words, spacing L21 between the connection terminal 33 and the light emitting device 35, and the second main surface 53 may be smaller than spacing L22 between the connection terminal 33 and the light emitting device 35, and the first main surface 51.

In this case, it is easy to maintain a thickness of the holder 23 between the connection terminal 33 and the light emitting device 35, and the first main surface 51. Accordingly, it is easy to improve constraining stability of the first blade member 25 with respect to the holder 23. Additionally, damage to the first wiring 37 due to the first blade member 25 is less likely to occur. If spacing between the connection terminal 33 and the second main surface 53 is different from spacing between the light emitting device 35 and the second main surface 53, the above-mentioned configuration may be evaluated on the basis of one which has larger spacing.

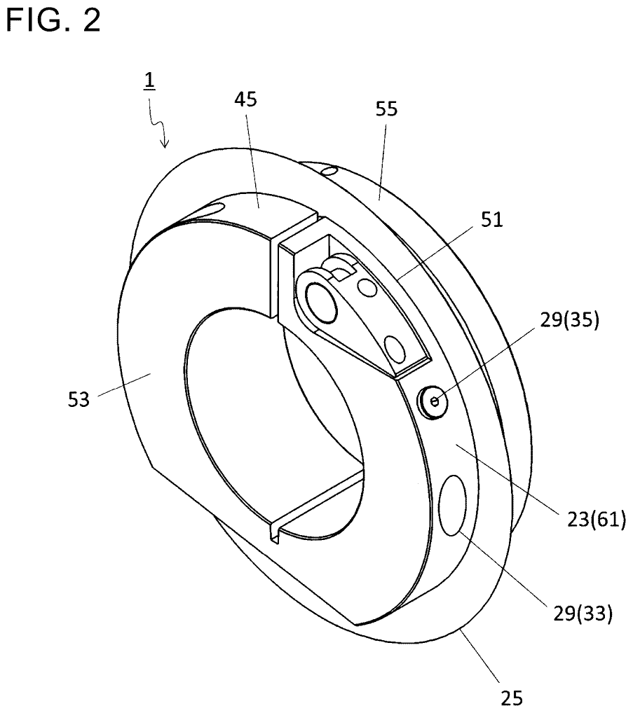

The holder 23 may include an outer circumferential surface 61 as in the non-limiting embodiment illustrated in FIG. 2. The light emitting device 35 may be attached to the outer circumferential surface 61. In these cases, it is easy to visually recognize the light emitting device 35. If the holder 23 includes the main body 45, the main body 45 may include the outer circumferential surface 61. The outer circumferential surface 61 may be located between the first main surface 51 and the second main surface 53. The light emitting device 35 may be protruded from the outer circumferential surface 61. If the light emitting device 35 is protruded therefrom, the light emitting device 35 may be located between the outer circumferential surface 61 and a diameter of the first blade member 25.

The connection terminal 33 may be attached to the outer circumferential surface 61. In this case, it is easy to attach the first wiring 37 to the connection terminal 33. If the light emitting device 35 and the connection terminal 33 are attached to the outer circumferential surface 61, the connection terminal 33 and the light emitting device 35 may be located along a circumferential direction of the holder 23.

The first wiring 37 may be detachably attached to the connection terminal 33. This makes it possible to separate the first wiring 37 from the connection terminal 33 after checking a contact situation of the first blade member 25 and the second blade member 27. Therefore, the first wiring 37 is less prone to damage when cutting down a sheet-shaped member. For example, the unit 1 may include a detachable connector, and the first wiring 37 may be detachably attached to the connection terminal 33 by the connector.

The power source 31, the connection terminal 33, the light emitting device 35, the first wiring 37, the second wiring 39, the third wiring 41, and the fourth wiring 43, all of which constitute the detection means 29, need not have an integral and inseparable shape, but may be partially removable. For example, the third wiring 41 and the fourth wiring 43 are attached to the interior of the main body 45 of the holder 23, whereas members, such as the light emitting device 35 and a translucent member 67, may be removable from the main body 45. With this configuration, if the light emitting device 35 and the translucent member 67 are deteriorated, only these members are replaceable, and there is no need to replace the main body 45.

The unit 1 may include a plurality of holders 23, a plurality of first blade members 25, a plurality of second blade members 27, and a plurality of light emitting devices 35. The plurality of light emitting devices 35 may be arranged in a row along the first rotation axis O1 as in the non-limiting embodiment illustrated in FIG. 1. In these cases, it is easy to visually recognize the light emitting devices 35.

The plurality of light emitting devices 35 are capable of individually emitting light in the above case. Hence, instead of collective detection for collectively detecting the presence/absence of contact in the plurality of first blade members 25 and the plurality of second blade members 27, separate detection for separately detecting the presence/absence of contact becomes possible. Consequently, it is easy to efficiently detect the presence/absence of the contact in the plurality of first blade members 25 and the plurality of second blade members 27, and it is easy to inhibit occurrence of poor cutting.

The detection means 29 may include a switch 63. The switch 63 is capable of performing on-off control of a current flow. If the detection means 29 includes the switch 63, activation can be done only when it is desired to check a cutting edge position. The position of the switch 63 is not particularly limited as long as the switch 63 serves its function.

A unit for a cutting apparatus 1A (hereinafter referred to as “a unit 1A” in some cases) in other non-limiting embodiment of the present disclosure is described below. The following is focused on differences between the unit 1A and the unit 1, and a detailed description of components having the same configuration as those in the unit 1 may be omitted in some cases. Accordingly, the description of the unit 1 may be referred to in order to understand the configuration of the unit 1A. This is also true for a unit 1B described later.

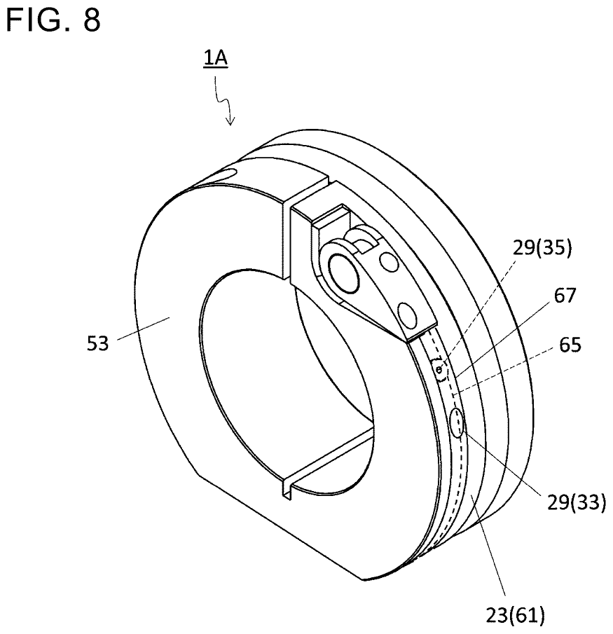

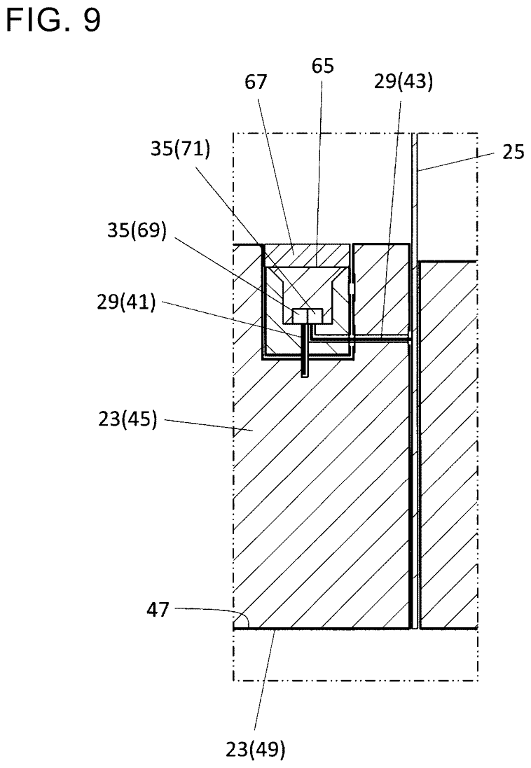

As in a non-limiting embodiment illustrated in FIGS. 8 and 9, the holder 23 may include a concave part 65 having an annular shape located on an outer circumferential surface 61 in the unit 1A. A light emitting device 35 may be attached to the concave part 65. In these cases, the light emitting device 35 is less prone to damage. The concave part 65 may be rephrased as a groove.

The unit 1A may further include a translucent member 67. The translucent member 67 may be attached to the concave part 65, and may have an annular shape covering the light emitting device 35. In these cases, the light emitting device 35 is less prone to damage.

Examples of material of the translucent member 67 may include glass and translucent resin. Examples of the translucent resin may include PMMA (PolyMethyl MethAcrylate: acryl) resin, PET (PolyEthylene Terephthalate) resin, and PC (PolyCarbonate) resin. Translucency in the translucent member 67 may be a degree to which the light emitting devices 35 can be visually observed through the translucent member 67.

The light emitting device 35 may include a first light emitting element 69 and a second light emitting element 71. The second light emitting element 71 may emit light of a color different from that of the first light emitting element 69. In these cases, it becomes possible to separately display purposes and positional relationship of a cutting tool located at a cutting portion.

A connection terminal 33 may be attached to the concave part 65 so as to be exposed from the translucent member 67.

A unit for a cutting apparatus 1B (hereinafter referred to as “a unit 1B” in some cases) in other non-limiting embodiment of the present disclosure is described below.

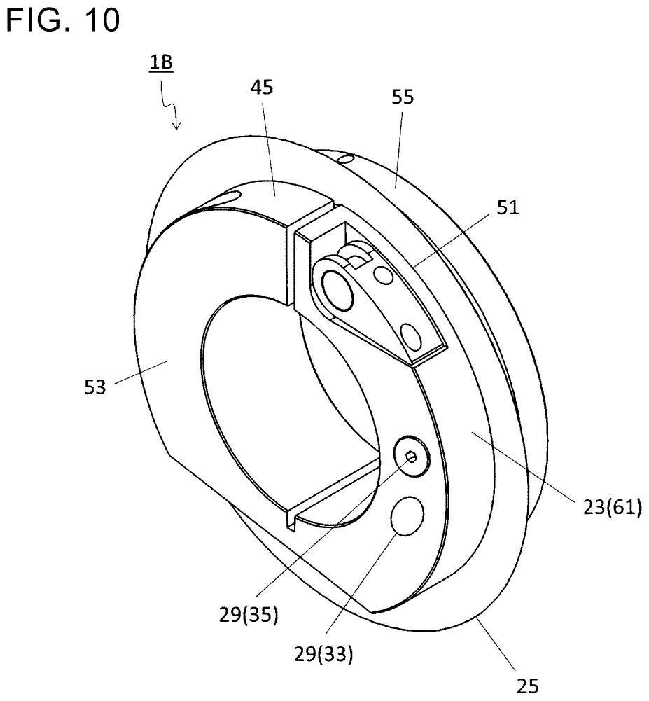

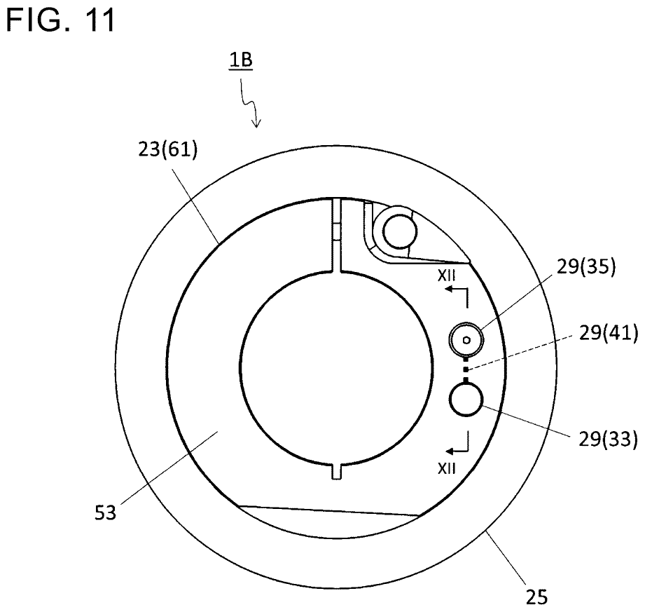

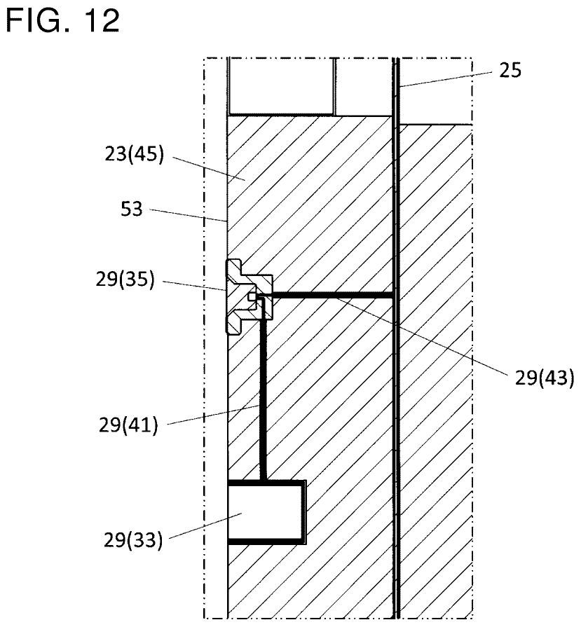

As in a non-limiting embodiment illustrated in FIGS. 10 to 12, a light emitting device 35 and a connection terminal 33 may be attached to a second main surface 53 in the unit 1B. In this case, the light emitting device 35 and the connection terminal 33 are less prone to damage.

If the light emitting device 35 and the connection terminal 33 are attached to the second main surface 53, the connection terminal 33 and the light emitting device 35 may be located along a circumferential direction of a holder 23.

### Cutting Apparatus

A cutting apparatus 101 in a non-limiting embodiment of the present disclosure is described in detail below with reference to the drawing by exemplifying the case of including the unit 1.

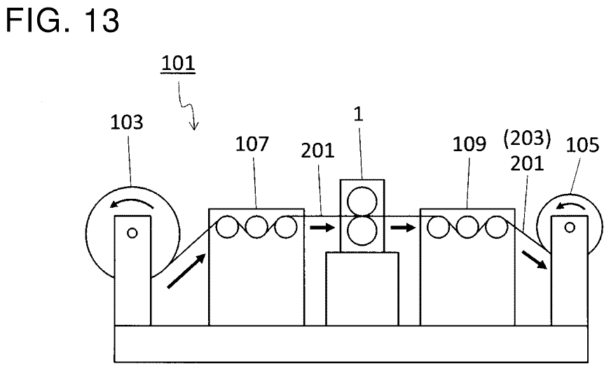

The cutting apparatus 101 may include the unit 1, a first roll 103, and a second roll 105 as in the non-limiting embodiment illustrated in FIG. 13. If the cutting apparatus 101 includes the unit 1, poor cutting is less likely to occur.

A sheet-shaped member 201 may be wound around the first roll 103, and the first roll 103 may feed the sheet-shaped member 201 to the unit 1. The first roll 103 may serve as a supply mechanism for supplying the sheet-shaped member 201 to the unit 1. When using the cutting apparatus 101, the sheet-shaped member 201 wound around the first roll 103 may be fed to the unit 1 by rotation of the first roll 103.

The second roll 105 may take up the sheet-shaped member 201 cut down by the unit 1. The second roll 105 may serve as a take-up mechanism for taking up the sheet-shaped member 201 cut down by the unit 1.

There may be one or a plurality of second rolls 105. If there is the single second roll 105, the sheet-shaped member 201 cut down into individual pieces by the unit 1 may be collectively taken up by the single second roll 105. If there are the plurality of second rolls 105, the sheet-shaped member 201 cut down into individual pieces by the unit 1 may be respectively taken up by the plurality of second rolls 105. The sheet-shaped member 201 cut down into the individual pieces by the unit 1 may be rephrased as sheet fragments 203.

The cutting apparatus 101 may include a first guide roll 107 located between the unit 1 and the first roll 103. This makes it possible to supply the sheet-shaped member 201 from the first roll 103 through the first guide roll 107 to the unit 1, and therefore, a supply state of the sheet-shaped member 201 tends to be stable. The first guide roll 107 may be made up of one roll or a plurality of rolls.

The cutting apparatus 101 may include a second guide roll 109 located between the unit 1 and the second roll 105. This makes it possible to transport the sheet fragment 203 from the unit 1 through the second guide roll 109 to the second roll 105, and therefore, a transport state of the sheet fragment 203 tends to be stable. The second guide roll 109 may be made up of one roll or a plurality of rolls.

Although the cutting apparatus 101 includes the unit 1 in the non-limiting embodiment illustrated in FIG. 13, there is no intention of limiting to this embodiment. For example, the cutting apparatus 101 may include the unit 1A or the unit 1B.

### Method for Manufacturing Sheet Fragment

A method for manufacturing a sheet fragment 203 in a non-limiting embodiment of the present disclosure is described in detail below with reference to the drawing by exemplifying the case of using the unit 1.

The sheet fragment 203 may be manufactured by cutting down a sheet-shape member 201 as in the non-limiting embodiment illustrated in FIG. 13. The method for manufacturing the sheet fragment 203 may include the following steps:
(1) Electrically connecting the connection terminal 33 and the first wiring 37 in the unit 1;
(2) Checking a contact situation of the first blade member 25 and the second blade member 27 by the detection means 29;
(3) Separating the first wiring 37 from the connection terminal 33; and
(4) Cutting down the sheet-shaped member 201 by the first blade member 25 and the second blade member 27.

If the unit 1 is used in the method for manufacturing the sheet fragment 203, poor cutting is less likely to occur.

Examples of the sheet-shaped member 201 may include members, such as a metal foil, paper, and a resin film.

Although the cutting apparatus 101 including the unit 1 is used in the non-limiting embodiment illustrated in FIG. 13, there is no intention of limiting to this embodiment. For example, the unit 1A or the unit 1B may be used.

While the units 1, 1A and 1B for the cutting apparatus, the cutting apparatus 101, and the method for manufacturing the sheet fragment 203 in the non-limiting embodiments have been exemplified above, the present disclosure is not limited to the above embodiments. It is needless to say that any arbitrary one can be made without departing from the scope of the present disclosure.

For example, the units 1, 1A and 1B for the cutting apparatus, the cutting apparatus 101, and the method for manufacturing the sheet fragment 203 may be configured as follows:
(1) A unit for a cutting apparatus includes a base, a first shaft that is attached to the base and extends along a first rotation axis, a holder having a cylindrical shape attached to the first shaft, a first blade member having an annular shape attached to the holder, a second shaft extending along a second rotation axis parallel to the first rotation axis, a second blade member having a cylindrical shape attached to the second shaft, and a detection means for detecting contact of the first blade member and the second blade member. Each of the second shaft, the first blade member, and the second blade member has conductivity. The detection means includes a power source, a connection terminal attached to the holder, a light emitting device attached to the holder, first wiring that electrically connects the connection terminal and the power source, second wiring that electrically connects the second shaft and the power source, third wiring that electrically connects the light emitting device and the connection terminal, and fourth wiring that electrically connects the light emitting device and the first blade member.
(2) In the unit for the cutting apparatus of the above (1), spacing between the connection terminal and the light emitting device may be a half or less of an outer diameter of the holder.
(3) In the unit for the cutting apparatus of the above (1) or (2), the holder may include a first main surface and a second main surface located on a side opposite to the first main surface. The first blade member may come into contact with the first main surface. The connection terminal and the light emitting device may be located closer to the second main surface than the first main surface.
(4) In the unit for the cutting apparatus of any one of the above (1) to (3), the holder may include an outer circumferential surface, and the light emitting device may be attached to the outer circumferential surface.
(5) The unit for the cutting apparatus of any one of the above (1) to (4) may include a plurality of the holders, a plurality of the first blade members, a plurality of the second blade members, and a plurality of the light emitting devices. The plurality of the light emitting devices may be arranged in a row along the first rotation axis.
(6) In the unit for the cutting apparatus of any one of the above (1) to (5), the holder may include an outer circumferential surface and a concave part having an annular shape located on the outer circumferential surface. The light emitting device may be attached to the concave part.
(7) The unit for the cutting apparatus of the above (6) may further include a translucent member having an annular shape which is attached to the concave part and covers the light emitting device.
(8) In the unit for the cutting apparatus of any one of the above (1) to (7), the detection means may include a switch.
(9) In the unit for the cutting apparatus of any one of the above (1) to (8), the light emitting device may include a first light emitting element, and a second light emitting element that emits light of a color different from that of the first light emitting element.
(10) A cutting apparatus is capable of including the unit for the cutting apparatus of any one of the above (1) to (9), a first roll that permits winding of a sheet-shaped member therearound and feeds the sheet-shaped member to the unit for the cutting apparatus, and a second roll that takes up the sheet-shaped member cut down by the unit for the cutting apparatus.
(11) A method for manufacturing a sheet fragment is capable of including the step of electrically connecting the connection terminal and the first wiring in the unit for the cutting apparatus of any one of the above (1) to (9), the step of checking a contact situation of the first blade member and the second blade member by the detection means, the step of separating the first wiring from the connection terminal, and the step of cutting down the sheet-shaped member by the first blade member and the second blade member.

### DESCRIPTION OF THE REFERENCE NUMERAL

1 unit for cutting apparatus (unit)
3 base
5 first shaft
7 second shaft
9 lower plate part
11 sidewall part
13 upper surface
15 first support part
17 second support part
19 first bearing member
21 second bearing member
23 holder
25 first blade member
27 second blade member
29 detection means
31 power source
33 connection terminal
35 light emitting device
37 first wiring
39 second wiring
41 third wiring
43 fourth wiring
45 main body
47 inner circumferential surface
49 coating film (insulating film)
51 first main surface
53 second main surface
55 lid body
57 male screw
59 female screw
61 outer circumferential surface
63 switch
65 concave part
67 translucent member
69 first light emitting element
71 second light emitting element
101 cutting apparatus
103 first roll
105 second roll
107 first guide roll
109 second guide roll
201 sheet-shaped member
203 sheet fragment
O1 first rotation axis
O2 second rotation axis

1. A unit for a cutting apparatus, comprising:
a base;
a first shaft that is attached to the base and extends along a first rotation axis;
a holder having a cylindrical shape attached to the first shaft;
a first blade member having an annular shape attached to the holder;
a second shaft that is attached to the base and extends along a second rotation axis parallel to the first rotation axis;
a second blade member having a cylindrical shape attached to the second shaft; and
a detection means for detecting contact of the first blade member and the second blade member,
wherein
the second shaft, the first blade member, and the second blade member individually have conductivity,
the detection means comprises
a power source,
a connection terminal attached to the holder,
a light emitting device attached to the holder,
first wiring electrically connecting the connection terminal and the power source,
second wiring electrically connecting the second shaft and the power source,
third wiring electrically connecting the light emitting device and the connection terminal, and
fourth wiring electrically connecting the light emitting device and the first blade member.

2. The unit for the cutting apparatus according to claim 1, wherein spacing between the connection terminal and the light emitting device is a half or less of an outer diameter of the holder.

3. The unit for the cutting apparatus according to claim 1 wherein
the holder comprises a first main surface and a second main surface located on a side opposite to the first main surface,
the first blade member comes into contact with the first main surface, and
the connection terminal and the light emitting device are located closer to the second main surface than the first main surface.

4. The unit for the cutting apparatus according to claim 1, wherein
the holder comprises an outer circumferential surface, and
the light emitting device is attached to the outer circumferential surface.

5. The unit for the cutting apparatus according to claim 1, wherein
the unit comprises a plurality of the holders, a plurality of the first blade members, a plurality of the second blade members, and a plurality of the light emitting devices, and
the plurality of the light emitting devices are arranged in a row along the first rotation axis.

6. The unit for the cutting apparatus according to claim 1, wherein
the holder comprises
an outer circumferential surface, and
a concave part having an annular shape which is located on the outer circumferential surface, and
the light emitting device is attached to the concave part.

7. The unit for the cutting apparatus according to claim 6, further comprising:
a translucent member having an annular shape which is attached to the concave part and covers the light emitting device.

8. The unit for the cutting apparatus according to claim 1, wherein the detection means comprises a switch.

9. The unit for the cutting apparatus according to claim 1, wherein
the light emitting device comprises
a first light emitting element, and
a second light emitting element that emits light of a color different from that of the first light emitting element.

10. A cutting apparatus comprises:
the unit for the cutting apparatus according to claim 1;
a first roll that permits winding of a sheet-shaped member therearound and feeds the sheet-shaped member to the unit for the cutting apparatus; and
a second roll that takes up the sheet-shaped member cut down by the unit for the cutting apparatus.

11. A method for manufacturing a sheet fragment comprises:
electrically connecting the connection terminal and the first wiring in the unit for the cutting apparatus of claim 1;
checking a contact situation of the first blade member and the second blade member by the detection means;
separating the first wiring from the connection terminal; and
cutting down a sheet-shaped member by the first blade member and the second blade member.
